(19) United States
(12) Patent Application Publication
(10) Pub. No.: US 2019/0147355 A1
(43) Pub. Date: May 16, 2019

(54) SELF-CRITICAL SEQUENCE TRAINING OF MULTIMODAL SYSTEMS

(71) Applicant: International Business Machines Corporation, Armonk, NY (US)

(72) Inventors: Steven J. Rennie, Yorktown Heights, NY (US); Etienne Marcheret, White Plains, NY (US); Youssef Mroueh, New York, NY (US); Vaibhava Goel, Chappaqua, NY (US); Jarret Ross, Wichita, KS (US); Pierre L. Dognin, White Plains, NY (US)

(21) Appl. No.: 15/811,728

(22) Filed: Nov. 14, 2017

(51) Int. Cl. G06N 5/04; G05B 13/04; G05B 13/02

(52) U.S. Cl. CPC G06N 5/046; G05B 13/042; G06N 3/04; G05B 13/0255; G05B 13/026; G05B 13/027

(57) ABSTRACT

Machine logic for: (i) selecting a sampled word for use as a next word in a text stream; (ii) determining, by an algorithm, an expected future reward value for the sampled word using a test policy including a training policy and a test-time inference procedure; and (iii) normalizing a set of expected future reward estimate(s) using the expected future reward value for the sampled word.

### STATEMENT ON PRIOR DISCLOSURES BY AN INVENTOR

The following disclosure(s) are submitted under 35 U.S.C. 102(b)(1)(A) as potential prior disclosures by, or on behalf of, a sole inventor of the present application or a joint inventor of the present application: (i) “System and Method for Self-critical Sequence Training of Multimodal Systems” by Rennie et al., submitted confidentially, on 15 Nov. 2016, to the Computer Vision Foundation for consideration for inclusion in one of the conferences that the Foundation hosts; and (ii) “Self-critical Sequence Training for Image Captioning” by Rennie et al., published 2 Dec. 2016 by arVix and/or the Cornell University Library.

### BACKGROUND

The present invention relates generally to the field of computer systems predicting sequences that maximize with a non-differentiable reward.

One type of computer system that predicts sequences maximizing a non-differentiable reward (Natural language metric in this case) is used for captioning (for example, image captioning (including still image captioning and video image captioning), audio captioning (for example, closed captioning television dialogue). Captioning, as that term is used herein, refers to providing explanatory natural language text associated with some kind of content (for example, video image content, still image content, audio stream content). For example, closed captioning on television is one type of audio captioning. Providing captions for still images (like photographs) or video images will herein be collectively referred to as “image captioning.”

“Reinforcement learning (RL) algorithm,” as that term is used herein, refers to any prediction algorithm that includes the use of machine learning inspired by behaviorist psychology, concerned with how software agents ought to take actions in an environment so as to maximize some notion of cumulative reward. A “reward function,” as that term is used in this document means. At least some known RL algorithms “normalize” their rewards.

RL algorithms are typically formulated as a Markov decision process (MDP). Some known RL algorithms use dynamic programming. One typical difference between the classical techniques and RL algorithms is that RL algorithms do not need knowledge about the MDP and they target large MDPs where exact methods can become impractical. RL algorithms typically differ from standard supervised learning in that correct input/output pairs are not presented, and sub-optimal actions are not explicitly corrected. Rather, in RL algorithms consider on-line performance, including making a balance between exploration (of uncharted territory) and exploitation (of current knowledge). This trade-off in reinforcement learning has been developed through work on the “multi-armed bandit problem” and in the context of finite MDPs.

An RL algorithm typically performs the following operations: (i) an agent takes action(s) in an environment; (ii) these action(s) are interpreted into a reward and a representation of the state; and (iii) this reward and representation of state is fed back into the agent. In some conventional RL algorithms, a basic reinforcement is modeled as a Markov decision process. The rules are typically stochastic. The observation typically involves the scalar immediate reward associated with the last transition. In many works, the agent is assumed to observe the current environmental state (full observability). If not, the agent has partial observability. Sometimes the set of actions available to the agent is restricted (if a balance is zero, it cannot be reduced).

REINFORCE algorithms (also herein referred to as “reinforce-type algorithms”) are a type of RL algorithms that have machine logic based rules designed to choose actions to maximize immediate reward. Reinforce-type algorithms have identified a broad class of update rules that perform gradient descent on the expected reward and showed how to integrate these rules with backpropagation. One specific type of reinforce-type algorithm uses linear reward-inaction as a special case. Reinforce-type algorithms typically include: (i) a reinforcement baseline; and (ii) a probability density function used to randomly generate actions based on unit activations. In a reinforce-type algorithm, the choice of baseline can have a profound effect on a “convergence speed” of the algorithm. Reinforce-type algorithms are a class of associative reinforcement learning algorithms for “connectionist networks” containing stochastic units. Connectionist networks (or artificial neural networks) use an approach to the study of cognition that utilizes mathematical models. Typically, connectionist networks include highly interconnected, neuron-like processing units. There is no sharp dividing line between connectionism and computational neuroscience, but connectionists are typically less focused on specific details of neural functioning, and instead focus on high-level cognitive processes (such as, recognition). Reinforce-type algorithms choose a direction for weight adjustments so that the direction of the weight adjustment lies along a gradient of expected reinforcement in both of the following: (i) immediate-reinforcement tasks; and (ii) some limited forms of delayed-reinforcement tasks. Reinforce-type algorithms typically do this without explicitly computing gradient estimates or even storing information that could serve as a basis for determining such estimates. Typically, reinforce-type algorithms are integrated with backpropagation.

### SUMMARY

According to an aspect of the present invention, there is a method, computer program product and/or system that performs the following operations (not necessarily in the following order):

According to an aspect of the present invention, there is a method, computer program product and/or system that performs the following operations (not necessarily in the following order): (i) selecting a sampled word for use as a next word in a text stream; (ii) determining, by an algorithm, an expected future reward value for the sampled word using a test policy including a training policy and a test-time inference procedure; and (iii) normalizing a set of expected future reward estimate(s) using the expected future reward value for the sampled word.

In some embodiments, the sampled word is the same as a most greedy word for the text stream.

In some embodiments, the sampled word is different than the most greedy word for the text stream.

In some embodiments, the selection of the sampled words includes random sampling.

In some embodiments, the selection of the sampled words includes clustering.

In some embodiments, the algorithm is a REINFORCE type algorithm.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a flow chart of a first embodiment according to the present invention;

FIG. 6 is a data table showing information that is helpful in understanding embodiments of the present invention;

FIG. 7 is a data table showing information that is helpful in understanding embodiments of the present invention;

FIGS. 8A to 8D are data tables showing information that is helpful in understanding embodiments of the present invention;

FIG. 9 is a data table showing information that is helpful in understanding embodiments of the present invention;

FIG. 10 is an image showing information that is helpful in understanding embodiments of the present invention;

FIGS. 11A to 11F are screenshots showing information that is helpful in understanding embodiments of the present invention;

FIGS. 12A to 12D are graphical representations showing information that is helpful in understanding embodiments of the present invention;

FIG. 13 is an image showing information that is helpful in understanding embodiments of the present invention;

FIGS. 14A to 14F are screenshots showing information that is helpful in understanding embodiments of the present invention;

FIGS. 15A and 15B are heat maps showing information that is helpful in understanding embodiments of the present invention;

FIG. 16 is an image showing information that is helpful in understanding embodiments of the present invention;

FIGS. 17A to 17F are screenshots showing information that is helpful in understanding embodiments of the present invention;

FIG. 18 is an image showing information that is helpful in understanding embodiments of the present invention;

FIGS. 19A to 19F are screenshots showing information that is helpful in understanding embodiments of the present invention;

FIG. 20 is an image showing information that is helpful in understanding embodiments of the present invention; and

FIGS. 21A to 21F are screenshots showing information that is helpful in understanding embodiments of the present invention.

### DETAILED DESCRIPTION

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

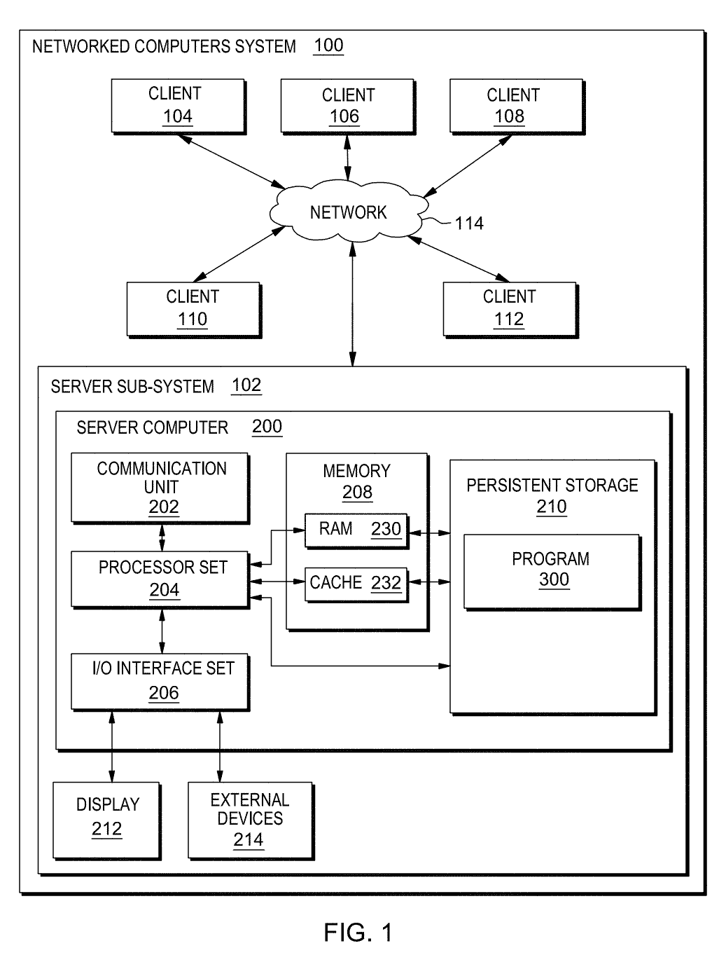

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments, the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

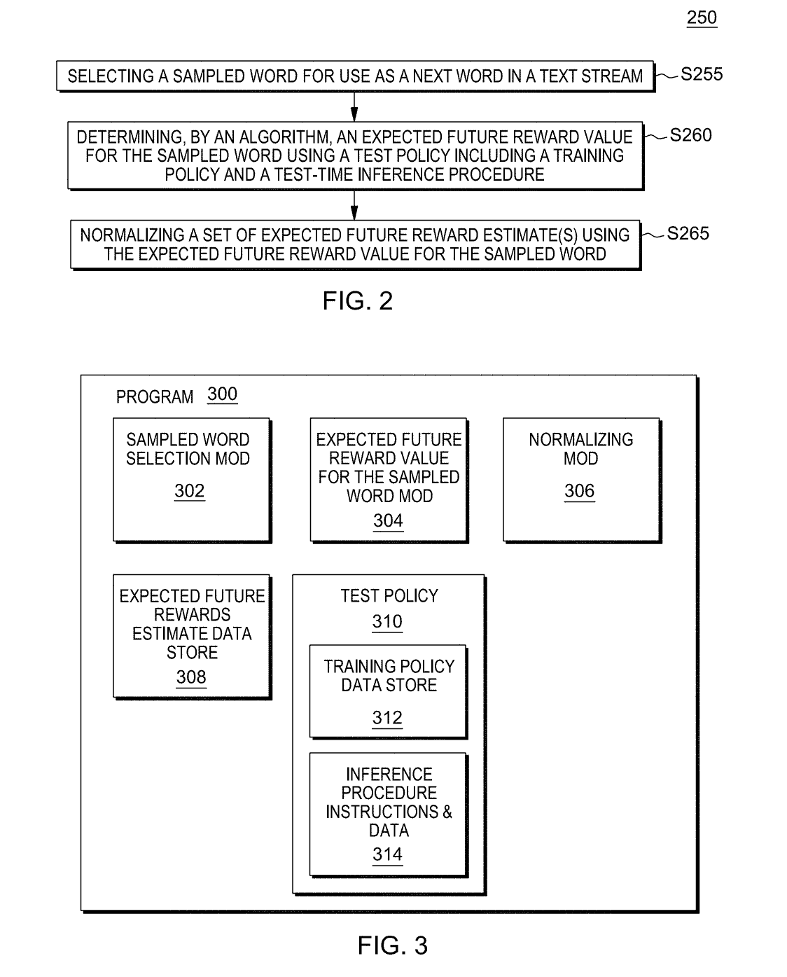

FIG. 2 shows flowchart 250 depicting a method according to the present invention. FIG. 3 shows program 300 for performing at least some of the method operations of flowchart 250. This method and associated software will now be discussed, over the course of the following paragraphs, with extensive reference to FIG. 2 (for the method operation blocks) and FIG. 3 (for the software blocks). While the example method of flowchart 250 is directed to sequence prediction in the context of image captioning, where the sequence is a caption and the items chosen for the caption are words (or small sets of words). Other embodiments of the present invention may be directed to choosing other types of items for inclusion in other types of sequences.

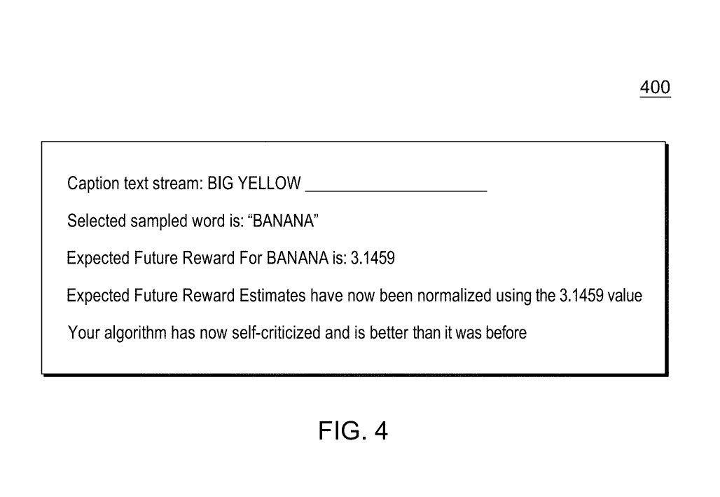

Processing begins at operation S255, where sampled word selection module (“mod”) 302 selects a sampled word for use as a next word in a text stream. The sampled word may or may not be the same as a most greedy word for the text stream. As will be explained in detail, below, in the next sub-section of this Detailed Description section, this selection may include clustering and/or random sampling. Screenshot 400 of FIG. 4, shows the text stream and selected sample word for this example.

Processing proceeds to operation S260 where expected future reward value for the sampled word mod 304 determines, by an algorithm, an expected future reward value for the sampled word using test policy 310 including training policy 312 and test-time inference procedure 314. In this example, the algorithm is a REINFORCE type algorithm. Screenshot 400 shows expected future reward for the sampled word used in this example.

Processing proceeds to operation S265 where normalizing mod 306 normalizes a set of expected future reward estimate(s) (stored in expected future rewards estimate data store 308) using the expected future reward value for the sampled word determined at operation S260. Screenshot 400 shows the normalization operation has been performed.

### III. Further Comments and/or Embodiments

It has been shown that policy-gradient methods for reinforcement learning can be utilized to train deep end-to-end systems directly on non-differentiable metrics for the task at hand. Some embodiments of the present invention consider the problem of optimizing image captioning systems using reinforcement learning, and show that by carefully optimizing our systems using the test metrics of the Common Objects in Context (COCO) task, significant gains in performance can be realized. Some embodiments of the present invention are built using an optimization approach called self-critical sequence training (SCST). SCST is a form of the popular REINFORCE algorithm that, rather than estimating a “baseline” to normalize the rewards and reduce variance, utilizes the output of its own test-time inference algorithm to normalize the rewards it experiences. Using this approach, estimating the reward signal (as actor-critic methods must do) and estimating normalization (as REINFORCE algorithms typically do) is avoided, while at the same time harmonizing the model with respect to its test-time inference procedure.

Empirically, it can be shown that directly optimizing the CIDEr metric with SCST and greedy decoding at test-time is highly effective. In some embodiments of the present invention, results on the COCO evaluation sever establish a new state-of-the-art on the task, improving the best result in terms of CIDEr from 104.9 to 112.3.

Image captioning aims at generating a natural language description of an image. Open domain captioning is a very challenging task, as it requires a fine-grained understanding of the global and the local entities in an image, as well as their attributes and relationships. The COCO challenge provides a new, larger scale platform for evaluating image captioning systems, complete with an evaluation server for benchmarking competing methods. Deep learning approaches to sequence modeling have yielded impressive results on the task, dominating the task leaderboard. Inspired by the recently introduced encoder/decoder paradigm for machine translation using recurrent neural networks (RNNs), some studies have shown to have used a deep convolutional neural network (CNN) to encode the input image, and a Long Short Term Memory (LSTM) RNN decoder to generate the output caption. These systems are trained end-to-end using back-propagation, and have achieved state-of-the-art results on COCO. More recently, the use of spatial attention mechanisms on CNN layers to incorporate visual context—which implicitly conditions on the text generated so far—was incorporated into the generation process. It has been shown that captioning systems that utilize attention mechanisms lead to better generalization because these models can compose novel text descriptions based on the recognition of the global and local entities that comprise images.

As discussed in some previous studies, deep generative models for text are typically trained to maximize the likelihood of the next ground-truth word given the previous ground-truth word using back-propagation. This approach has been called “Teacher-Forcing.” However, this approach creates a mismatch between training and testing, since at test-time the model uses the previously generated words from the model distribution to predict the next word. This exposure bias results in error accumulation during generation at test time, since the model has never been exposed to its own predictions.

Several approaches to overcoming the exposure bias problem described above have recently been proposed. Some studies have shown that feeding back the model's own predictions and slowly increasing the feedback probability p during training leads to significantly better test-time performance. Another line of work proposes “Professor-Forcing,” a technique that uses adversarial training to encourage the dynamics of the recurrent network to be the same when training conditioned on ground truth previous words and when sampling freely from the network. While sequence models are usually trained using the cross entropy loss, they are typically evaluated at test time using discrete and non-differentiable Natural Language Processing (NLP) metrics such as BLEU, ROUGE, METEOR or CIDEr. Ideally sequence models for image captioning should be trained to avoid exposure bias and directly optimize metrics for the task at hand.

Recently it has been shown that both the exposure bias and non-differentiable task metric issues can be addressed by incorporating techniques from Reinforcement Learning (RL). Specifically, some studies have been shown to have used the REINFORCE algorithm to directly optimize non-differentiable, sequence-based test metrics, and overcome both issues. REINFORCE allows one to optimize the gradient of the expected reward by sampling from the model during training, and treating those samples as ground-truth labels (that are re-weighted by the reward they deliver). The major limitation of this approach is that the expected gradient computed using mini-batches under REINFORCE typically exhibit high variance, and without proper context-dependent normalization, is typically unstable.

The recent discovery that REINFORCE with proper bias correction using learned “baselines” is effective has led to a flurry of work in applying REINFORCE to problems in RL, supervised learning, and variational inference. Actor-critic methods, which instead train a second “critic” network to provide an estimate of the value of each generated word given the policy of an actor network, have also been investigated for sequence problems recently. These techniques overcome the need to sample from the policy's (actors) action space, which can be enormous, at the expense of estimating future rewards, and training multiple networks based on one another's outputs, which can also be unstable.

Some embodiments of the present invention present a new approach to sequence training which called self-critical sequence training (SCST), and demonstrate that SCST can improve the performance of image captioning systems dramatically. SCST is a REINFORCE algorithm that, rather than estimating the reward signal, or how the reward signal should be normalized, utilizes the output of its own test-time inference algorithm to normalize the rewards it experiences. As a result, only samples from the model that outperform the current test-time system are given positive weight, and inferior samples are suppressed. Using SCST, attempting to estimate the reward signal, as actor-critic methods must do, and estimating normalization, as REINFORCE algorithms must do, is avoided, while at the same time harmonizing the model with respect to its test-time inference procedure. Empirically we find that directly optimizing the CIDEr metric with SCST and greedy decoding at test-time is highly effective. Results on the COCO evaluation server establish a new state-of-the-art on the task, improving the best result in terms of CIDEr from 104.9 to 112.3.

In the following paragraphs, various recurrent models used for caption generation are discussed, starting with fully connected (FC) models. Similar to methods employed in previous studies, embodiments of the present invention first encode the input image F using a deep CNN, and then embed it through a linear projection W_{I}. Words are represented with one hot vectors that are embedded with a linear embedding E that has the same output dimension as W_{I}. The beginning of each sentence is marked with a special BOS token, and the end with an EOS token. Under the model, words are generated and then fed back into the LSTM, with the image treated as the first word W_{I}CNN(F). The following updates for the hidden units and cells of an LSTM define the model:

xₜ=E1_{w}_{ₜ₋₁} for t>1,x₁=W_{I}CNN(F)

iₜ=σ(Wᵢₓxₜ+Wᵢₕhₜ₋₁+bᵢ) (Input Gate)

fₜ=σ(W_{fx}xₜ+W_{fh}hₜ₋₁+b_{f}) (Forget Gate)

oₜ=σ(Wₒₓxₜ+Wₒₕhₜ₋₁+bₒ) (Output Gate)

cₜ=iₜ⊙ϕ(W_{zx}^{⊗}xₜ+W_{zh}^{⊗}hₜ₋₁+b_{z}^{⊗})+fₜ⊙cₜ₋₁

hₜ=oₜ⊙ tan h(cₜ)

sₜ=Wₐhₜ,

where ϕ is a maxout non-linearity with 2 units (⊗ denotes the units) and σ is the sigmoid function. We initialize h₀ and c₀ to zero. The LSTM outputs a distribution over the next word wₜ using the softmax function:

wₜ˜softmax(sₜ) (1)

In some embodiments of the present invention, with respect to its architecture, the hidden states and word and image embeddings have dimension 512. Let θ denote the parameters of the model. Traditionally the parameters θ are learned by maximizing the likelihood of the observed sequence. Specifically, given a target ground truth sequence {w₁*, . . . , w_{T}*}, the objective is to minimize the cross entropy loss (XE):

$$L ( θ ) = - {\sum }_{t = 1}^{T} log ( {p}_{θ} ( {w}_{t}^{*} \vert {w}_{1}^{*} , … {w}_{t - 1}^{*} ) ) , \qquad ( 2 )$$

where: p_{θ}(wₜ|w₁, . . . wₜ₋₁)
is given by the parametric model in Equation (1).

In the following paragraphs, Attention Model (“Att2in”) will be discussed. Rather than utilizing a static, spatially pooled representation of the image, attention models dynamically re-weight the input spatial (CNN) features to focus on specific regions of the image at each time step. Some embodiments of the present invention modify the architecture of the attention model for captioning and input the attention-derived image feature only to the cell node of the LSTM. This architecture has been shown to outperform other designs when ADAM is used for optimization. Modifying the architecture of the attention model can be mathematically represented as follows:

xₜ=E1_{w}_{ₜ₋₁} for t≥1w₀=BOS(F)

iₜ=σ(Wᵢₓxₜ+Wᵢₕhₜ₋₁+bᵢ) (Input Gate)

fₜ=σ(W_{fx}xₜ+W_{fh}hₜ₋₁+b_{f}) (Forget Gate)

oₜ=σ(Wₒₓxₜ+Wₒₕhₜ₋₁+bₒ) (Output Gate)

cₜ=iₜ⊙ϕ(W_{zx}^{⊗}xₜ+W_{zI}^{⊗}Iₜ+W_{zh}^{⊗}hₜ₋₁+b_{z}^{⊗})+fₜ⊙cₜ₋₁

hₜ=oₜ⊙ tan h(cₜ)

sₜ=Wₐhₜ,

where Iₜ is the attention-derived image feature. This feature is derived as follows: given CNN features at the following N locations:

{I₁, . . . \check{I}_{N}},Iₜ=Σᵢ₋₁^{Ň}αₜⁱIᵢ,

where:

αₜ=softmax(αₜ+b_{α}).

and

αₜⁱ=W tan h(W_{αI}Iᵢ+W_{αh}hₜ₋₁+b_{α}).

Here, embodiments of the present invention set the dimension of W to 1×512, and set c₀ and h₀ to zero. Let θ denote the parameters of this model. Then p_{θ}(wₜ|w₁, . . . wₜ₋₁) is again defined by Equation (1). The parameters θ of attention models are also traditionally learned by optimizing the XE loss (See Equation (2)).

In the following paragraphs, Reinforcement Learning (RL) will be discussed. More specifically, in this paragraph, sequence generation as an RL problem will be discussed. As described above, captioning systems are traditionally trained using the cross entropy loss. To directly optimize NLP metrics and address the exposure bias issue, embodiments of the present invention can cast generative models in the Reinforcement Learning terminology. Embodiments of the present invention that include recurrent models (LSTM), introduced above, can be viewed as an “agent” that interacts with an external “environment” (such as words and image features). The parameters of the network, θ, define a policy p_{θ}, that results in an “action” (that is, the “action” is the prediction of the next word). After each action, the agent (the LSTM) updates its internal “state” (cells and hidden states of the LSTM, attention weights, etc.) Upon generating the end-of-sequence (EOS) token, the agent observes a “reward” (for instance, the CIDEr score of the generated sentence is considered a “reward”) and this reward is denoted by r. The reward is computed by an evaluation metric by comparing the generated sequence to corresponding ground-truth sequences. The goal of training is to minimize the negative expected reward:

L(θ)=− [symbol] _{w}_{^{s}}_{˜p}_{_{θ}}[r(w^{s})], (3)

where

w^{s}=(w₁^{s}, . . . w_{T}^{s})

and wᵢ^{s} is the word sampled from the model at the time step t. In practice L(θ) is typically estimated with a single sample from p_{θ}:

L(θ)≈−r(w^{s}),w^{s}˜p_{θ}.

In the following paragraph, policy gradient with REINFORCE will be discussed. In order to compute the gradient ∇_{θ}L(θ), embodiments of the present invention use the REINFORCE algorithm. REINFORCE is based on the observation that the expected gradient of a non-differentiable reward function can be computed as follows:

∇_{θ}L(θ)=− [symbol] _{w}_{^{s}}_{˜p}_{_{θ}}[r(w^{s})∇_{θ} log p_{θ}(w^{s})]. (4)

In practice, the expected gradient can be approximated using a single Monte-Carlo sample:

w^{s}=(w₁^{s} . . . w_{T}^{s})

from p_{θ}, for each training example in the minibatch:

∇_{θ}L(θ)≈−r(w^{s})∇_{θ} log p_{θ}(w^{s}).

In the following paragraph, REINFORCE with a baseline will be discussed. The policy gradient given by REINFORCE can be generalized to compute the reward associated with an action value relative to a reference reward or baseline b:

∇_{θ}L(θ)=− [symbol] _{w}_{^{s}}_{˜p}_{_{θ}}[(r(w^{s})−b)∇_{θ} log p_{θ}(w^{s})]. (5).

The baseline can be any arbitrary function, as long as it does not depend on the “action” w^{s} since in this case:

$$\begin{matrix}{{w}^{s} ∼ p θ}_{} [ b {∇}_{θ} log {p}_{θ} ( {w}^{s} ) ] = b {\sum }_{{w}_{s}}^{ } {∇}_{θ} {p}_{θ} ( {w}^{s} ) \\ = b {∇}_{θ} {\sum }_{{w}^{s}} {p}_{θ} ( {w}^{s} ) \\ = b {∇}_{θ} 1 = 0.\end{matrix} \qquad ( 6 )$$

This shows that the baseline does not change the expected gradient, but importantly, it can reduce the variance of the gradient estimate. For each training case, embodiments of the present invention again approximate the expected gradient with a single sample w^{s}˜p_{θ}:

∇_{θ}L(θ)≈−(r(w^{s})−b)∇_{θ}log p_{θ}(w^{s}). (7)

It is important to note that if b is a function of θ or t, equation (6) still holds and b(θ) is a valid baseline.

In the following paragraph, final gradient expression will be discussed. Using the chain rule, and the parametric model p_{θ}, embodiments of the present invention have:

$${∇}_{θ} L ( θ ) = {\sum }_{t = 1}^{T} \frac{\partial L ( θ )}{\partial {s}_{t}} \frac{\partial {s}_{t}}{\partial θ} ,$$

where sₜ is the input to the softmax function. Using REINFORCE with a baseline b the estimate of the gradient of

$$\frac{\partial L ( θ )}{\partial {s}_{t}}$$

is given by:

$$\frac{\partial L ( θ )}{\partial {s}_{t}} \approx ( r ( {w}^{s} ) - b ) ( {p}_{θ} ( {w}_{t} \vert {h}_{t} ) - {1}_{{w}_{t}^{s}} ) . \qquad ( 8 )$$

In the following paragraphs, self-critical sequence training (SCST) will be discussed in greater detail. The central idea of the self-critical sequence training (SCST) approach is to baseline the REINFORCE algorithm with the reward obtained by the current model under the inference algorithm used at test time. The gradient of the negative reward of a sample w^{s} from the model with respect to the softmax activations at time-step t then becomes:

$$\frac{\partial L ( θ )}{\partial {s}_{t}} \approx ( r ( {w}^{s} ) - r ( \hat{w} ) ) ( {p}_{θ} ( {w}_{t} \vert {h}_{t} ) - {1}_{{w}_{t}^{s}} ) . \qquad ( 9 )$$

where r(ŵ) again is the reward obtained by the current model under the inference algorithm used at test time. Accordingly, samples from the model that return a higher reward than ŵ will be “pushed up”, or increased in probability, while samples which result in a lower reward will be suppressed.

Like MIXER, SCST has all the advantages of REINFORCE algorithms because it directly optimizes the true, sequence-level, evaluation metric, but avoids the usual scenario of having to learn a (context-dependent) estimate of expected future rewards as a baseline. In practice, SCST has much lower variance, and can be more effectively trained on mini-batches of samples using Stochastic Gradient Descent (SGD). Since the SCST baseline is based on the test-time estimate under the current model, SCST is forced to improve the performance of the model under the inference algorithm used at test time. This encourages training/test time consistency like the maximum likelihood-based approaches, such as: “Data as Demonstrator,” “Professor Forcing,” and E2E, but importantly, it can directly optimize sequence metrics.

Finally, SCST is self-critical, and so avoids all the inherent training difficulties associated with actor-critic methods, where a second “critic” network must be trained to estimate value functions, and the actor must be trained on estimated value functions rather than actual rewards. Some embodiments of the present invention focus on scenario of greedy decoding, where:

$${\hat{w}}_{t} = arg {max}_{{w}_{t}} p ( {w}_{t} \vert {h}_{t} ) \qquad ( 10 )$$

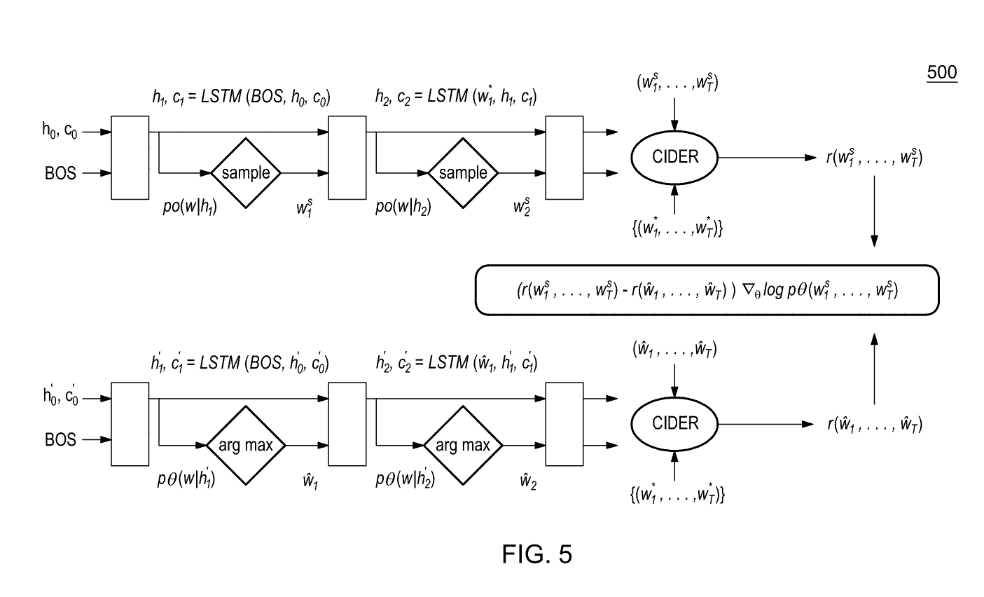

This choice, depicted in SCST flow chart 500 of FIG. 5 (described in greater detail below), has several practical advantages. First and foremost, it minimizes the impact of baselining with the test-time inference algorithm on training time, since it requires only one additional forward pass, and trains the system to be optimized for fast, greedy decoding at test-time. This choice may also be among the best forms of SCST based on a single test-time estimate, as suppressing all samples that underperform relative to the final test-time estimate will tend to favor a very decisive policy. The investigation of forms of SCST that incorporate margin, utilize more than one test time estimate (e.g. an n-best list) to baseline, and/or more elaborate test time inference procedures (e.g. beam search) are interesting possible directions of future work.

SCST flow chart 500 of FIG. 5 provides a visual illustration of SCST. Flow chart 500 shows that the weight put on words of a sampled sentence from the model is determined by the difference between the reward for the sampled sentence and the reward obtained by the estimated sentence under the test-time inference procedure (greedy inference depicted). This harmonizes learning with the inference procedure, and lowers the variance of the gradients, improving the training procedure.

Some embodiments of the present invention evaluate a method on the COCO dataset. The training set for this method contains 113, 287 images, along with five captions each. Embodiments of the present invention use a set of 5K images for validation and report results on a test set of 5K images as well. Additionally, embodiments of the present invention report four widely used automatic evaluation metrics, BLEU-4, ROUGEL, METEOR, and CIDEr. Finally, embodiments of the present invention prune the vocabulary and drop any word that has a count of less than five, resulting with a vocabulary of size 10096 words.

With respect to FC Models, embodiments of the present invention use two types of features, with the first being FC-2k features. FC-2k features encode each image with Resnet-101 (101 layers). It is important to note that embodiments of the present invention do not rescale or crop each image. Instead, they encode the full image with the final convolutional layer of resnet, and apply average pooling, which results in a vector of dimension 2048. The second feature is the FC-15k feature, which stacks the average pooled thirteen layers of Resnet-101 (11×1024 and 2×2048). These thirteen layers are the odd layers of conv4 and conv5, with the exception of the 23rd layer of conv4, which was omitted. This results in a feature vector of dimension 15360.

With respect to Spatial CNN features for Attention models (Att2in), embodiments of the present invention encode each image using the residual convolutional neural network (CNN) Resnet-101. It is important to note that embodiments of the present invention do not rescale or crop the image. Instead, they encode the full image with the final convolutional layer of Resnet-101, and apply spatially adaptive average pooling so that the output has a fixed size of 14×14×2048. At each time step, the attention model produces an attention mask over the 96 spatial locations. This mask is applied and then the result is spatially averaged to produce a 2048 dimension representation of the attended portion of the image.

The LSTM hidden, image, word and attention embeddings dimension are fixed to 512 for all of the models discussed herein. All of the models are trained according to the following recipe, except where otherwise noted. Embodiments of the present invention initialize all models by training the model under the XE objective using the ADAM optimizer with an initial learning rate of 5×10⁻⁴. Then, embodiments of the present invention anneal the learning rate by a factor of 0.8 every three epochs, and increase the probability of feeding back a sample of the word posterior by 0.05 every five epochs until a feedback probability 0.25 is reached. Embodiments of the present invention evaluate the model, at each epoch, on the development set and select the model with best CIDEr score as an initialization for SCST training. The SCST training initialized with the XE model to optimize the CIDEr metric (specifically, the CIDEr-D metric) is then run using ADAM with a learning rate 5×10⁻⁵. Initially when experimenting with FC-2k and FC-15k models, embodiments of the present invention utilize curriculum learning (CL) during training by increasing the number of words that are sampled and trained under CIDEr by one at each epoch (the prefix of the sentence remains under the XE criterion until eventually being subsumed). For the COCO task, CL is not required, and provides little to no boost in performance. The results reported for the FC-2k and FC-15k models are trained with CL, while the attention models are trained directly on the entire sentence for all epochs after being initialized by the XE seed models.

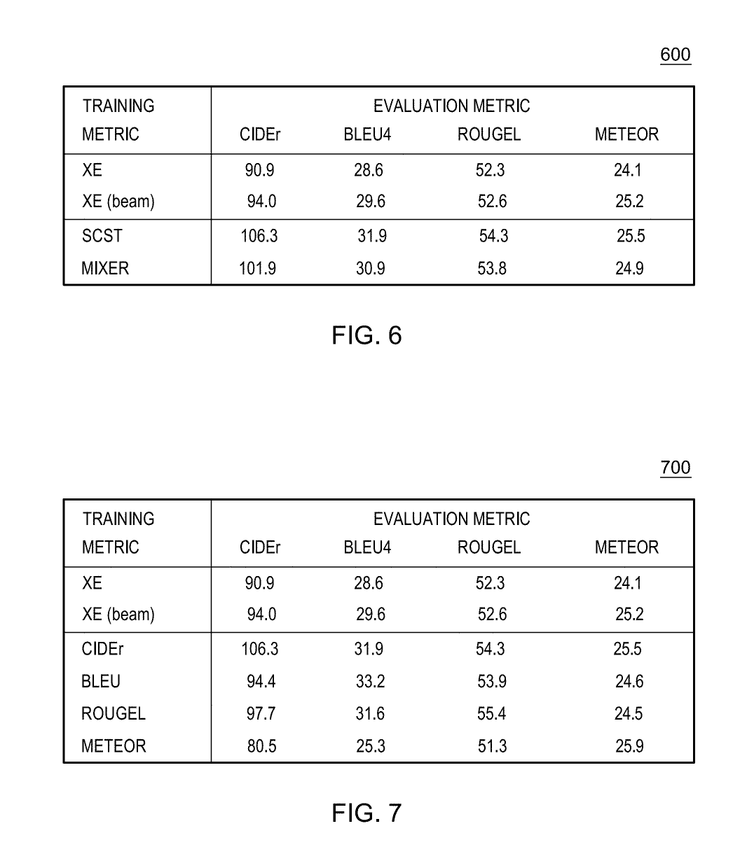

Table 600 of FIG. 6 is a first SCST data table. Table 600 compares the performance of SCST to that of MIXER on the test portion of the Karpathy splits. More specifically, table 600 shows the performance of SCST versus MIXER on the test portion of the Karpathy splits when trained to optimize the CIDEr metric (FC-2k models). Both significantly improve the seed cross-entropy trained model, but SCST significantly outperforms MIXER.

In this experiment, embodiments of the present invention utilize “curriculum learning” (CL) by optimizing the expected reward of the metric on the last n words of each training sentence, optimizing XE on the remaining sentence prefix, and slowly increasing n until the entire sentence is being sampled for all training cases. The results reported in table 600 were generated with a CL schedule matching the optimized schedule. Interestingly, it was found that CL was not necessary to successfully train both SCST and REINFORCE with a learned baseline on the COCO dataset. Rather, equally good results relative to not applying CL could be obtained by both a learned baseline and SCST. The gain of using SCST over using a learned baseline was consistently about four CIDEr points, regardless of the CL schedule (or lack thereof), and the initialization seed.

Table 700 of FIG. 7 is a second SCST data table that shows performance on the test portion of the Karpathy splits as a function of training metric (FC-2k models). The data shown in table 700 further shows that optimizing the CIDEr metric increases the overall performance under the evaluation metrics the most significantly. The performance of the seed cross-entropy (XE) model is also depicted. All models were decoded greedily, with the exception of the XE beam search result, which was optimized to beam three on the validation set.

Embodiments of the present invention trained directly on the evaluation metrics of the COCO challenge, and the results for FC-2k models are depicted in Table 700. In general, it can be seen that optimizing for a given metric during training leads to the best performance on that same metric at test time, which is an expected result. However, embodiments of the present invention trained on multiple test metrics, and found that it was not possible to outperform the overall performance of the model trained only on the CIDEr metric, which lifts the performance of all other metrics considerably. For this reason, most of the experimentation has since focused on optimizing CIDEr.

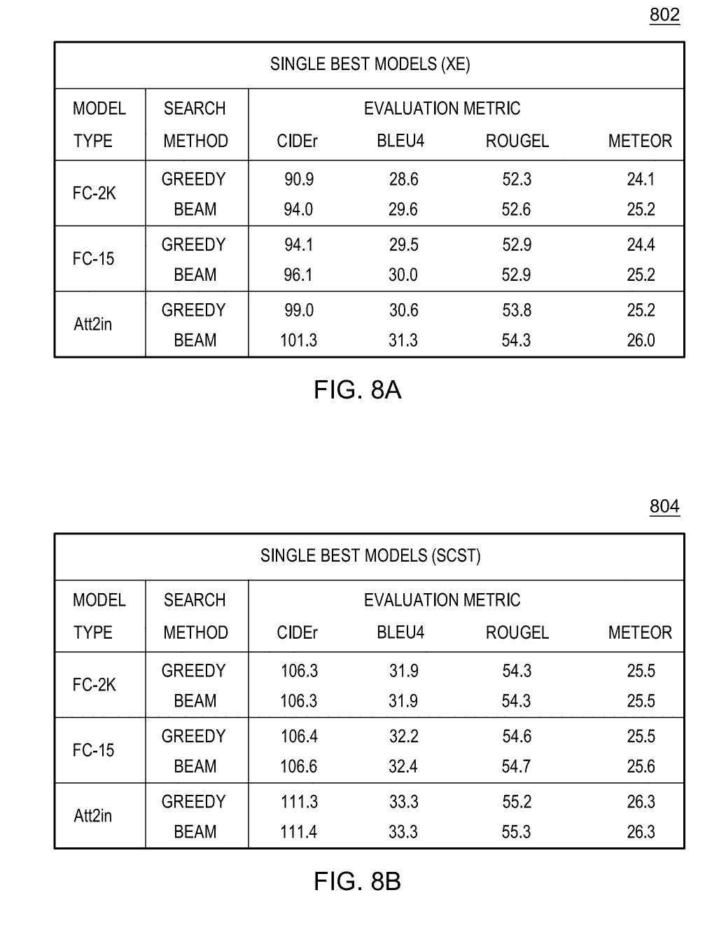

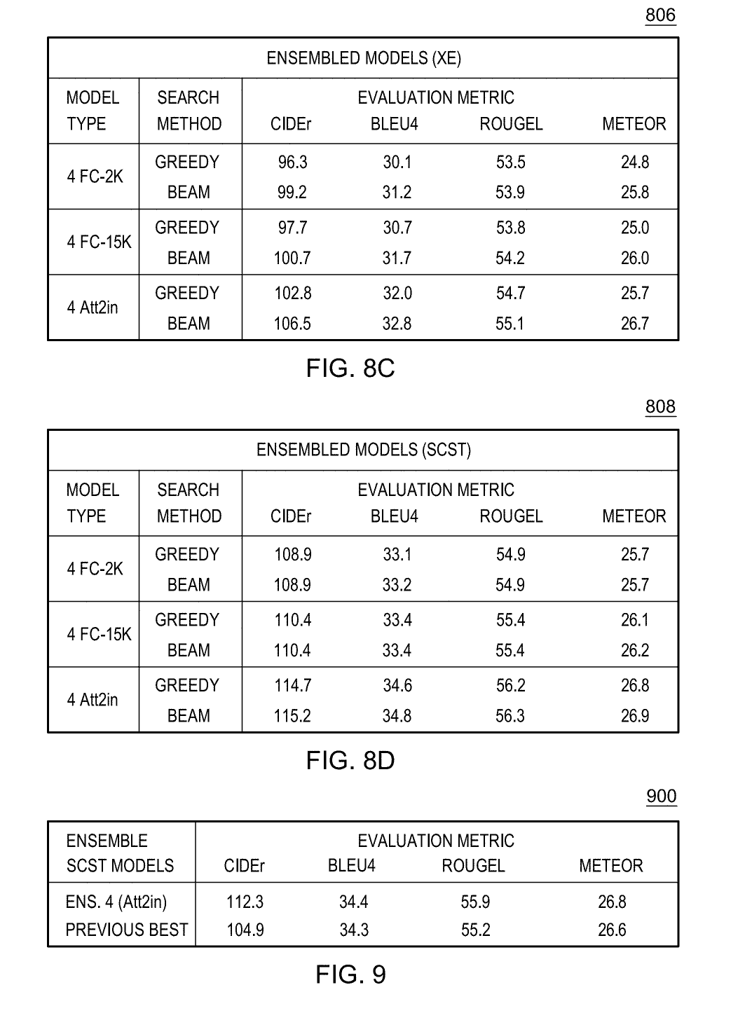

Tables 802 and 804 of FIGS. 8A and 8B, respectively, are data tables that show the performance of the best XE and corresponding SCST-trained single models on the test portion of the Karpathy splits (best over four random seeds). The results obtained via the greedy decoding of each word and optimized beam search are depicted. Models learned using SCST were trained to directly optimize the CIDEr metric. Tables 806 and 808 of FIGS. 8C and 8D are data tables that show performance of ensemble XE and SCST-trained models on the test portion of the Karpathy splits (ensemble over 4 random seeds). The models learned using self-critical sequence training (SCST) and were trained to optimize the CIDEr metric.

Some embodiments of the present invention trained FC models (2k and 15k), as well as attention models using SCST with the CIDEr metric. Four different models were trained for each FC and attention models, starting the optimization from four different random seeds. Tables 802 and 804 show the system with best performance for each family of models on the test portion of Karpathy splits. From this, it can be seen that the FC-15k models outperform the FC-2k models. Both FC models are outperformed by the attention model, and that establishes a new state of the art for a single model performance on Karpathy splits. It is important to note that this quantitative evaluation favors attention models, and is in-line with the observation that attention models tend to generalize better and compose outside of the context of the training of COCO.

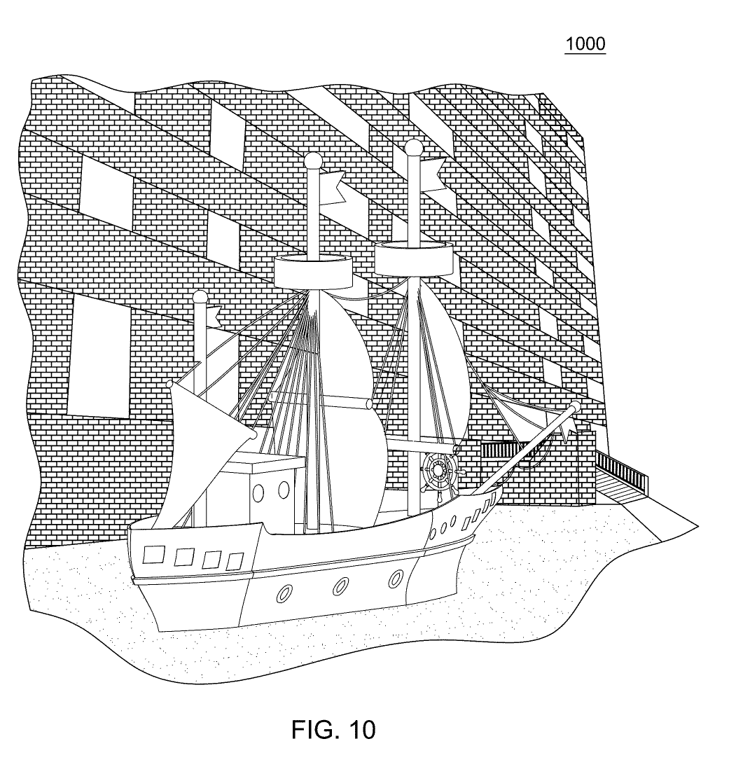

Table 900 of FIG. 9 is a data table that shows the performance of four ensembled attention models trained with self-critical sequence training (SCST) on the COCO evaluation server (with five reference captions). The previous best result on the leaderboard (as of Nov. 15, 2016) is also depicted (as found in Table C5, Watson Multimodal). Table 1000 of FIG. 10 further shows that the previous best system on all evaluation metrics is outperformed.

In some embodiments, an ensemble of the four models (mentioned above) are used and trained using SCST in the FC and in the attention modeling. Tables 806 and 808 show that ensembling improves performance and confirms the supremacy of attention modeling, and establishes yet another state of the art result on the Karpathy splits. It is important to note that embodiments of the present invention ensembled only four models and do not do any fine-tuning of the Resnet. NIC, in contrast, used an ensemble of fifteen models with fine-tuned CNNs.

Out-of-context image 1000 of FIG. 10 will now be discussed in detail. Image 1000 depicts a boat situated in an unusual context. Additionally, image 1000 is taken from an objects out-of-context (OOOC) dataset of images and tests the ability of the above-mentioned models to compose descriptions of images that differ from those seen during training. Image 1000 highlights the uniqueness of seeing a depiction of a ship outside of the context of a body of water, such as a large lake or ocean. Image 1000 provides a qualitative example of the captions generated by the systems for the input image.

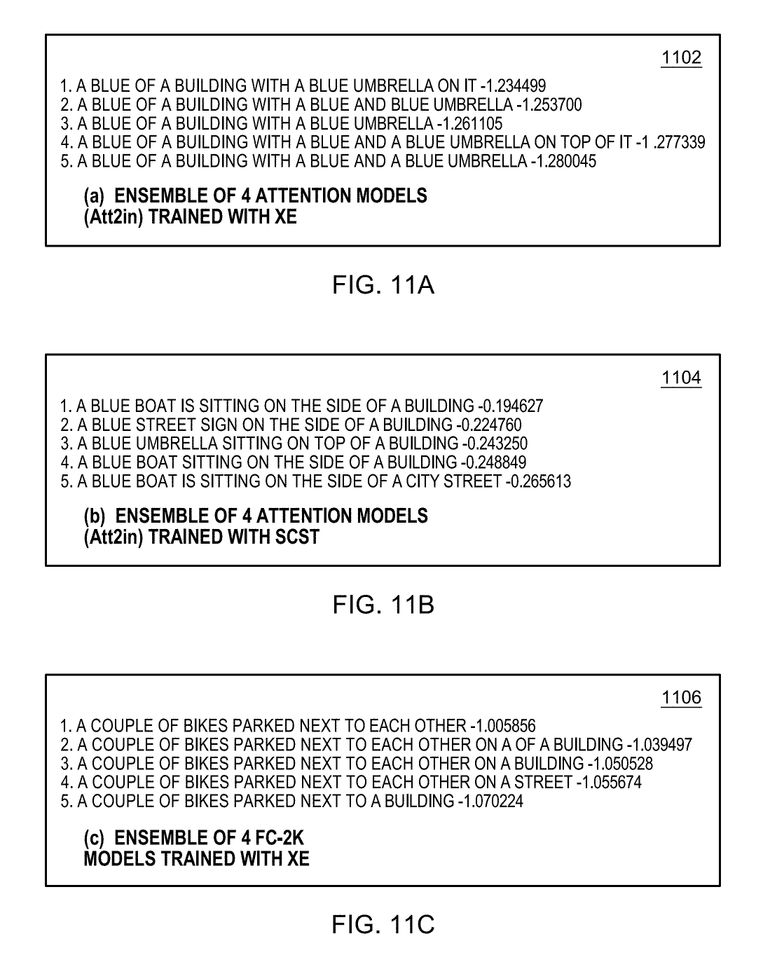

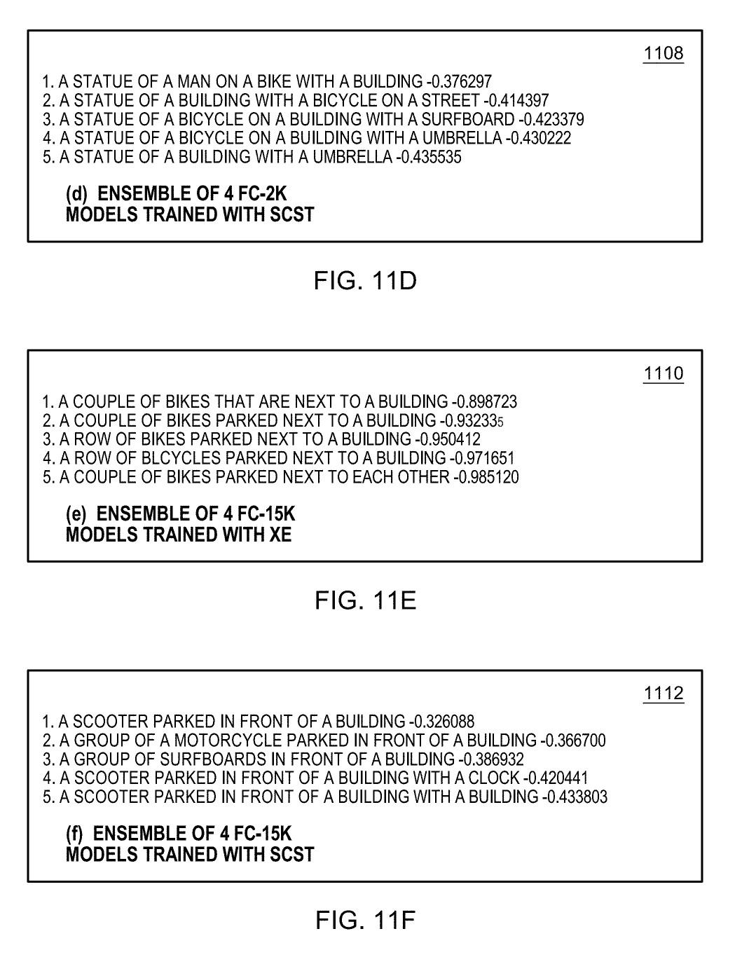

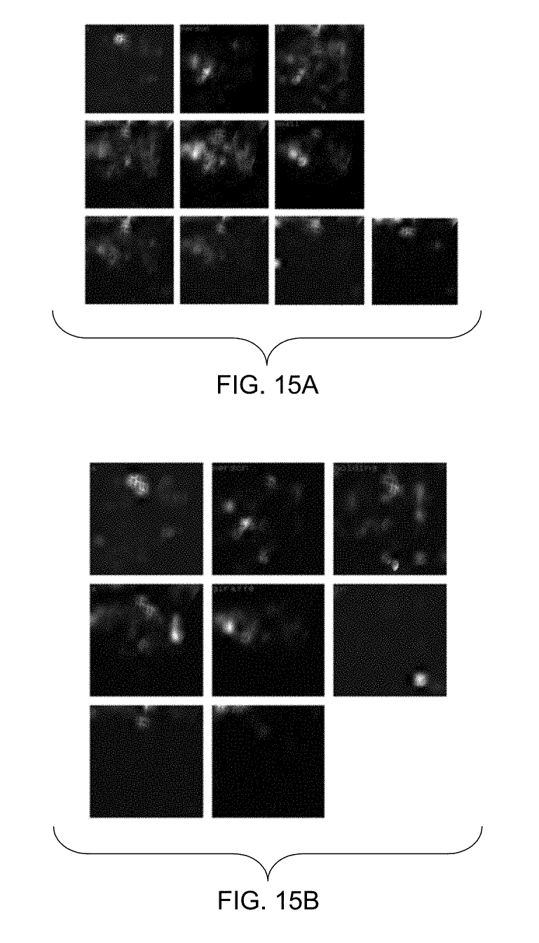

The top five captions returned by the XE and SCST-trained FC-2K, FC-15K, and attention model ensembles when deployed with a decoding “beam” of five are depicted in FIG. 11. With respect to image 1000, the FC models fail completely, and the SCST-trained ensemble of attention models is the only system that is able to correctly describe the image. In general, the performance of all captioning systems on COCO data is qualitatively similar; however, with respect to images containing objects situated in an uncommon context (unlike the COCO training set), the attention models perform much better, and SCST-trained attention models output even more accurate and descriptive captions. In general, the SCST-trained attention models describe images more accurately and with higher confidence (as reflected in FIG. 11 (discussed below), where the average of the log-likelihoods of the words in each generated caption are also depicted). Additional examples, including an example with the corresponding heatmaps generated by the SCST-trained ensemble of attention models (as shown by heatmaps 1502 and 1504 of FIGS. 15A and 15B, respectively).

Embodiments of the present invention present a simple and efficient approach to more effectively baselining the REINFORCE algorithm for policy-gradient based RL, which allows for more effective training on non-differentiable metrics, and leads to significant improvements in captioning performance on COCO—the results on the COCO evaluation server establish a new state-of-the-art on the task. The self-critical approach: (i) normalizes the reward obtained by sampled sentences, with the reward obtained by the model under the test-time inference algorithm being intuitive, and (ii) avoids having to estimate any state-dependent or independent reward functions. Extensions of SCST that incorporate margin or utilize more than one test-time estimate (such as an n-best list) to baseline, and/or more elaborate test-time inference procedures (such as beam search) are interesting possible directions of future work.

In the following paragraph, trained ensemble screenshots 1102-1112 of FIGS. 11A-11F (collectively FIG. 11), respectively, will be discussed. Screenshots 1102-1112 are screenshot captions generated for image 1000 by the various models (discussed above). Beside each caption, the average log probability of the words in the caption is reported. With respect to image 1000, which presents an object situated in an atypical context, the FC models fail to give an accurate description, while the attention models handle the previously unseen image composition well. The models trained with SCST return a more accurate and more detailed summary of the image.

In the following paragraph, the beam search procedure will be discussed in greater detail. Embodiments of the present invention refer to caption results and evaluation metric results obtained using “beam search.” While decoding a given image to generate captions that describe it, rather than greedily selecting the most probable word (N=1), a list of the N most probable sub-sequences generated so far can be maintained, which generates posterior probabilities for the next word of each of these subsequences, and then again prunes down to the N-best sub-sequences. This approach is widely referred to as a beam search, where N is the width of the decoding “beam.” Embodiments of the present invention additionally prune away hypotheses within the N-best list that have a log probability that is below that of the maximally probable partial sentence by more than Δ_{log}=20. For all reported results, the value of N is tuned on a per-model basis on the validation set of the Karpathy splits. With respect to COCO data, N=2 is typically optimal for cross-entropy (XE) trained models and SCST-trained models, but in the latter case beam search provides only a very small boost in performance. Embodiments of the present invention set N=5 for all models for captioning demonstrations, illustrative purposes and because it has been qualitatively observed that for test images that are substantially different from those encountered during training, beam search is important.

In the following paragraphs, performance of XE as compared to SCST trained models will be discussed in greater detail. Tables 802-808 of FIGS. 8A-8D, respectively, compare the performance of models trained to optimize the CIDEr metric with self-critical sequence training (SCST) with that of their corresponding bootstrap models, which were trained under the cross entropy (XE) criterion using scheduled sampling. Embodiments of the present invention show that for all XE models, the probability p_{f} of feeding forward the maximally probable word rather than the ground-truth word was increased by 0.05 every five epochs until reaching a maximum value of 0.25. The XE model with the best performance on the validation set of the Karpathy splits was then selected as the bootstrap model for SCST.

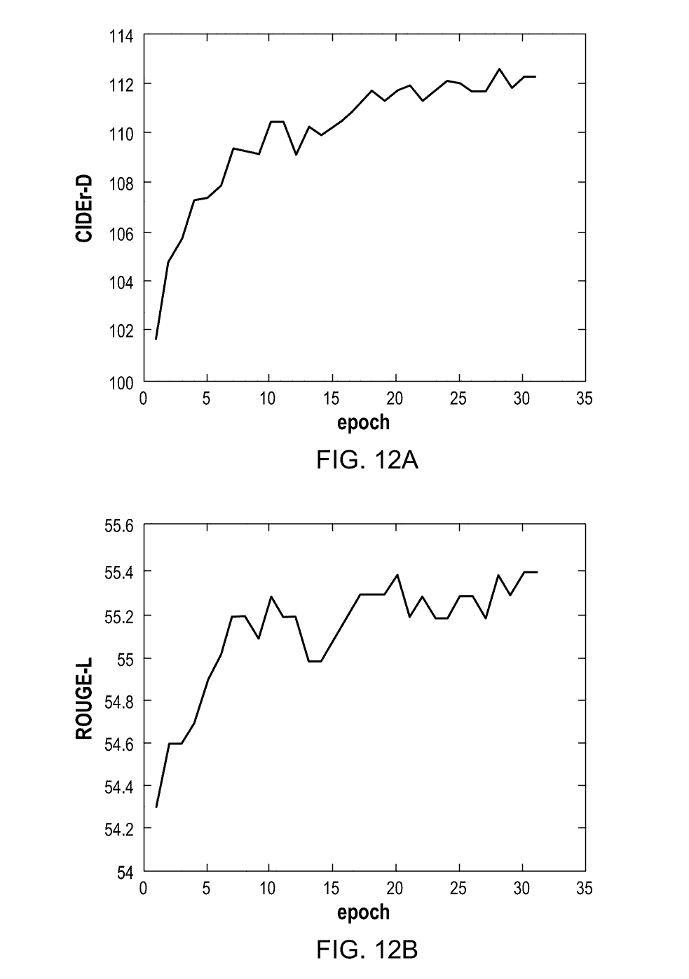

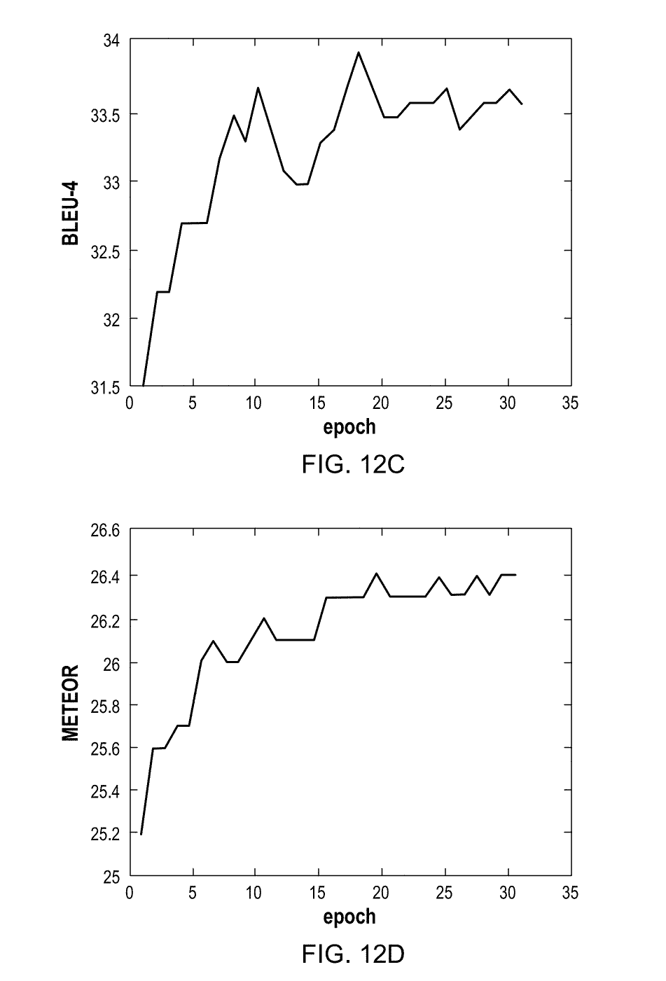

FIGS. 12A-12D (collectively referred to as FIG. 12) are graphical representations (or models) of performance data for the various metrics (discussed above). In particular, FIG. 12 shows the following: (i) FIG. 12A shows the performance of the CIDEr-D metric relative to a given epoch; (ii) FIG. 12B shows the performance of the ROUGE-L metric relative to a given epoch; (iii) FIG. 12C shows the performance of the BLEU-4 metric relative to a given epoch; and (iv) FIG. 12D shows the performance of the METEOR metric relative to a given epoch. For all of these models in FIG. 12, the performance of greedily decoding each word at test time and the performance of beam search (as described above) is reported. Embodiments of the present invention show that beam search using RL-trained models resulted in very little performance gain. FIG. 12 depicts the performance of the best Att2in model, which is trained to directly optimize the CIDEr metric as a function of training the epoch and evaluation metrics on the validation portion of the Karpathy splits. Embodiments of the present invention show that optimizing CIDEr clearly substantially improves all of the COCO evaluation metrics.

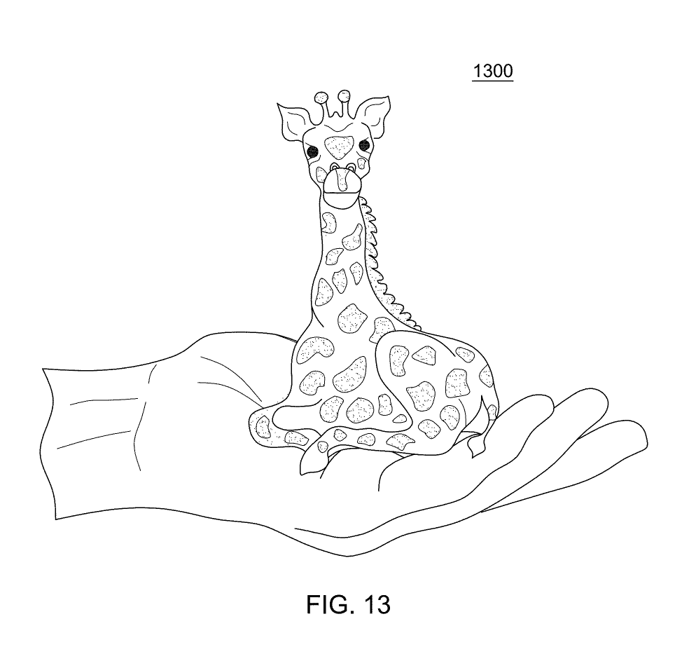

With respect to examples of generated captions, FIGS. 13-21 depict demonstrations of the captioning performance of all systems. In general, embodiments of the present invention show that the performance of all captioning systems on COCO data is qualitatively similar, while on images containing objects situated in an uncommon context (that is, unlike the COCO training set), the attention models perform much better, and SCST-trained attention models output even more accurate and descriptive captions. Attention heatmaps for the image and corresponding captions depicted in FIG. 13 are shown in FIG. 15. The heatmaps of the attention weights are reasonably in-line with the predicted words in both cases. Additionally, embodiments of the present invention show that the SCST attention weights are spatially sharper here (in FIG. 15B), and in general.

In the following paragraphs, SCST will be discussed in further detail. One detail that was crucial to optimizing CIDEr to produce better models was to include the EOS tag as a word. Embodiments of the present invention show that when the EOS word was omitted, trivial sentence fragments such as “with a” and “and a” were dominating the metric gains, despite the “gaming” counter-measures (such as sentence length and precision clipping) that are included in CIDEr-D, which is what is being optimized. Including the EOS tag substantially lowers the reward allocated to incomplete sentences, and completely resolves this issue.

Another detail that is important with respect to SCST is to associate the reward for the sentence with the first EOS encountered. Embodiments of the present invention show that omitting the reward from the first EOS fails to reward sentence completion, which leads to run-ons, and rewarding any words that follow the first EOS token is inconsistent with the decoding procedure. Embodiments of the present invention focus on optimizing the CIDEr metric because optimizing CIDER substantially improves all COCO evaluation metrics (as shown in tables 802-808 and in FIG. 12). Nevertheless, directly optimizing another metric does lead to higher evaluation scores on that same metric as shown. Consequently, embodiments of the present invention experiment with including models trained on Bleu, Rouge-L, and METEOR in the Att2in ensemble to attempt to improve it further. So far, performance has not been substantially improved with respect to the other metrics without substantially degrading CIDEr.

Image 1300 of FIG. 13 shows a picture of a common object in COCO (a giraffe) situation in an uncommon context (out of COCO domain). In particular, image 1300 shows the giraffe (the common object in COCO) rested inside of a pair of human hands (which, in reality, is an impossible place for an ordinary giraffe to be) and is therefore an object that is outside of the common context.

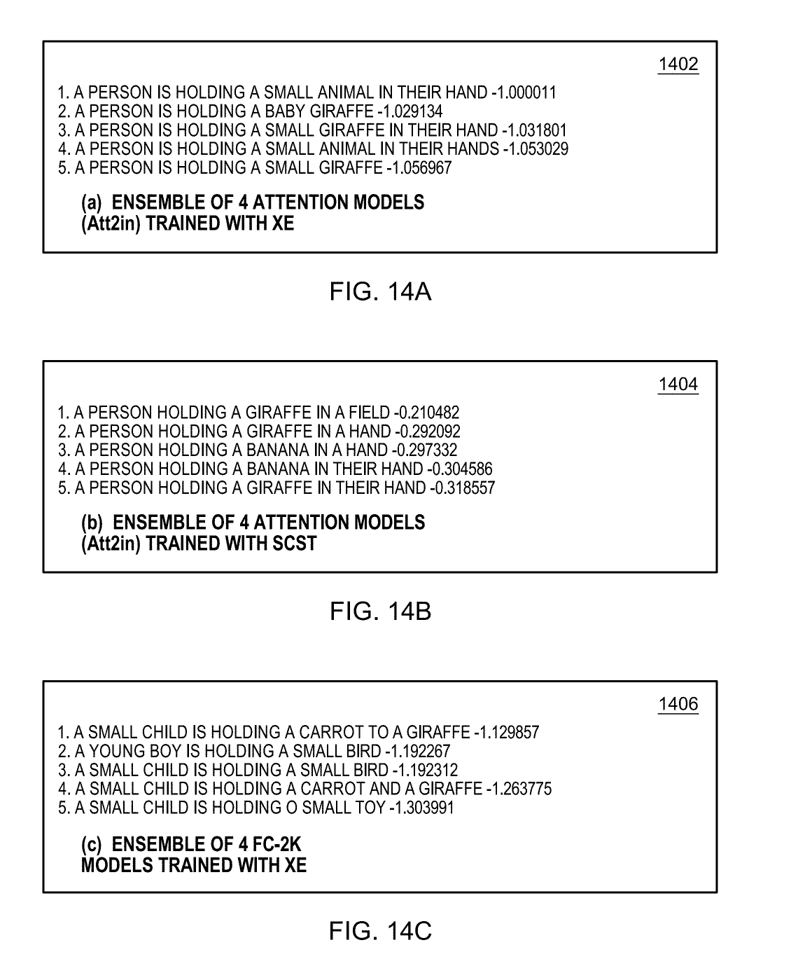

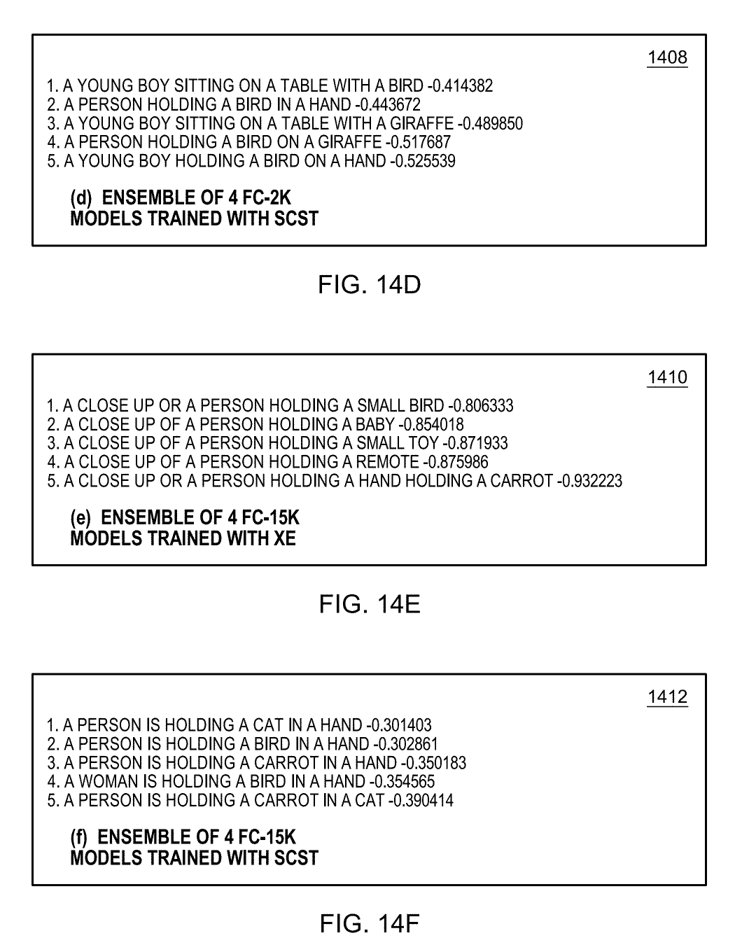

Screenshots 1402-1412 of FIGS. 14A-14F (collectively FIG. 14), respectively, are a series of screenshot captions that depict natural language captions generated by various models (described above) with respect to image 1300. Each of screenshots 1402-1412 report the average of the log probabilities of each word and the log probabilities are normalized by the sentence length. It is important to note the following observations: (i) the attention models trained with SCST give an accurate description of this image with high confidence; (ii) attention models trained with XE are less confident about the correct description; and (iii) FC models trained with CE or SCST fail at giving an accurate description.

Heatmaps 1502 and 1504 of FIGS. 15A and 15B (collectively FIG. 15), respectively, are attention heatmaps for the best model in the trained ensemble of attention models with respect to image 1300. Heatmap 1502 shows the best model in the XE-trained ensemble of attention models, and heatmap 1504 shows the best model in the SCST-trained ensemble of attention models.

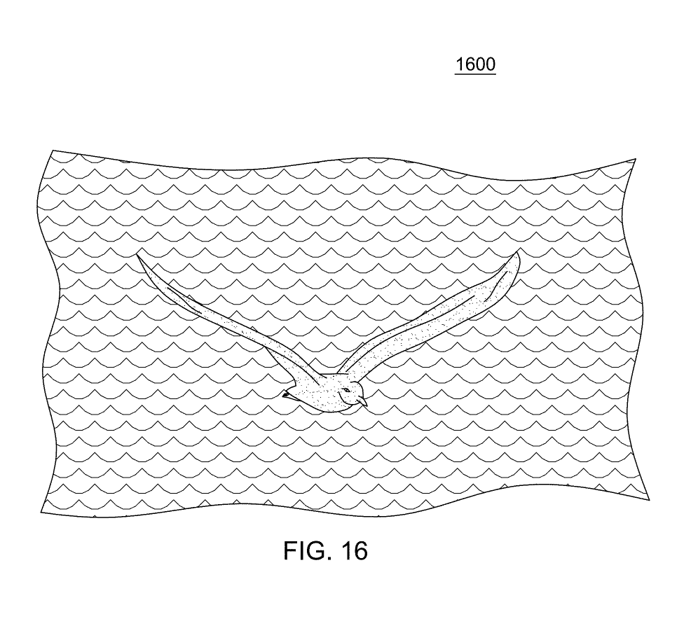

Image 1600 of FIG. 16 is an image from the COCO test set depicting a seagull over the image. The seagull depicted in image 1600 is a picture of a common object (seagull) in a common context (flying over the ocean).

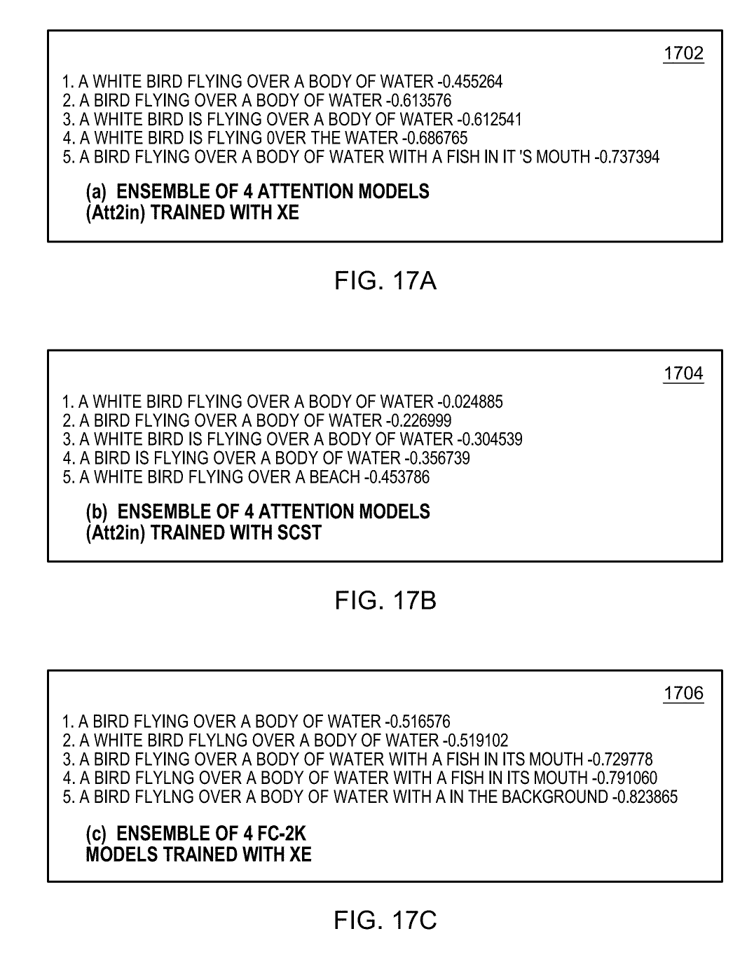

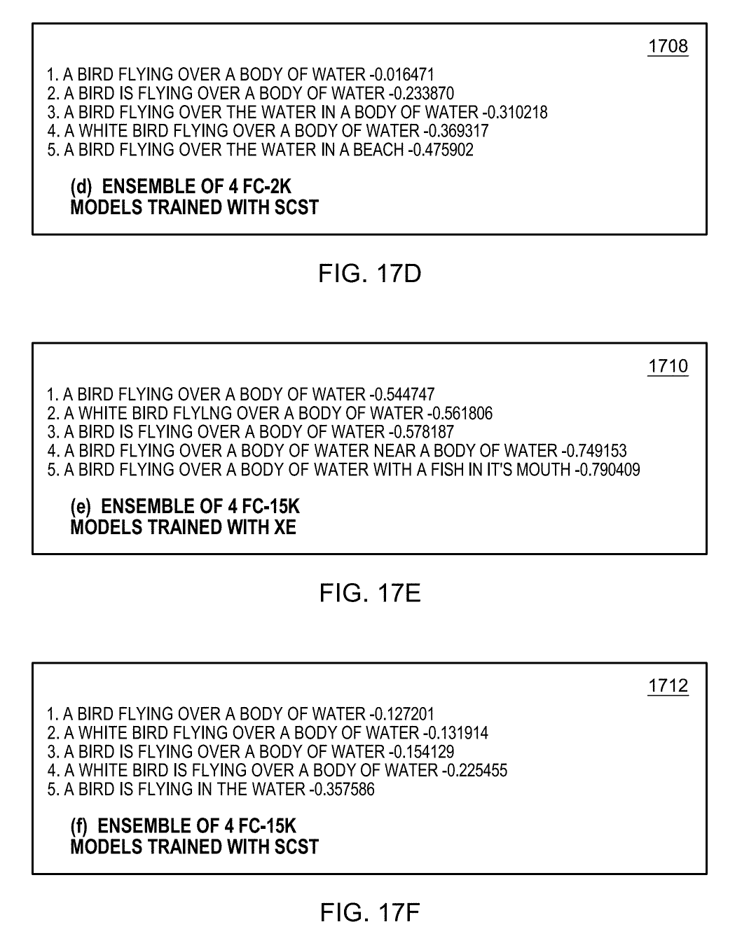

Screenshots 1702-1712 of FIGS. 17A-17F (collectively FIG. 17), respectively, are a series of captions generated with respect to image 1600 by the various models (described above). Each caption reports the average log probability of the words that are gleaned from image 1600 (for instance, “white bird flying over a body of water”). Each caption of FIG. 17 shows that all models perform well on this test image (image 1600) from the COCO distribution. More generally, all models perform (qualitatively) comparably on the COCO test images (in this case, image 1600).

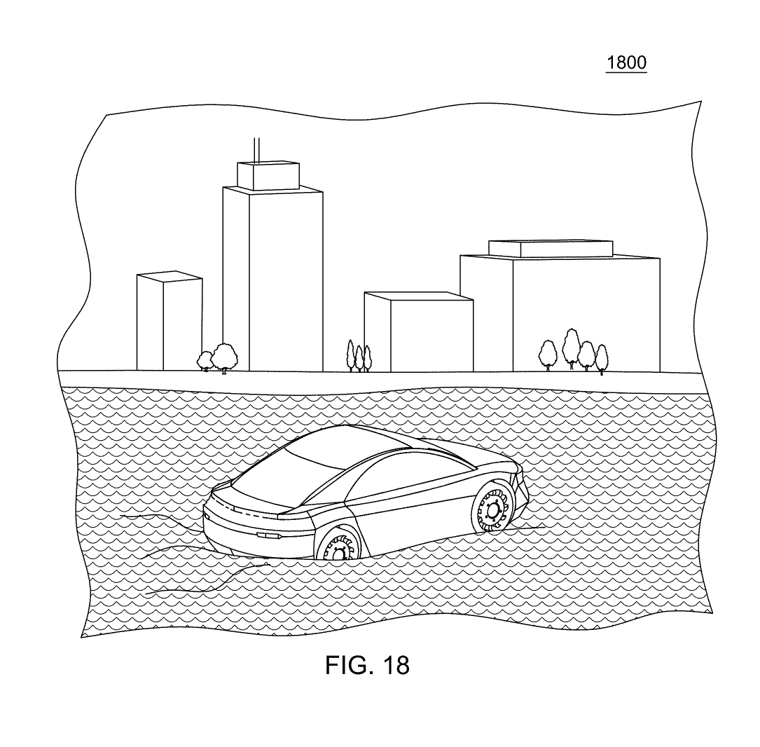

Image 1800 of FIG. 18 is an image from the objects out-of-context (OOOC) dataset of images depicting a red car in the middle of a body of water with a set of buildings beside the water.

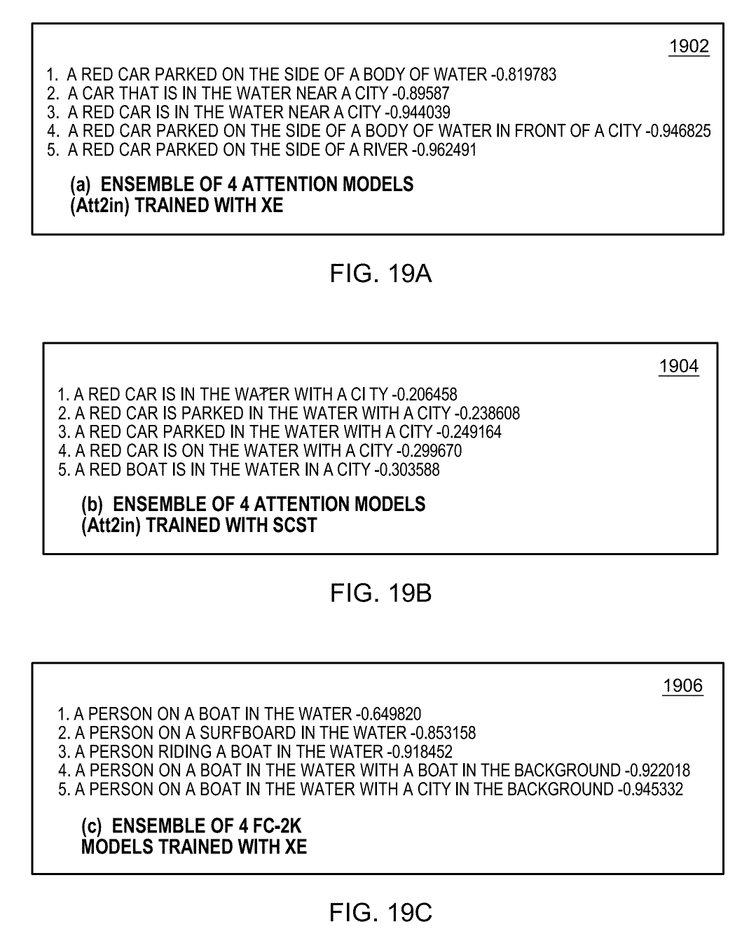

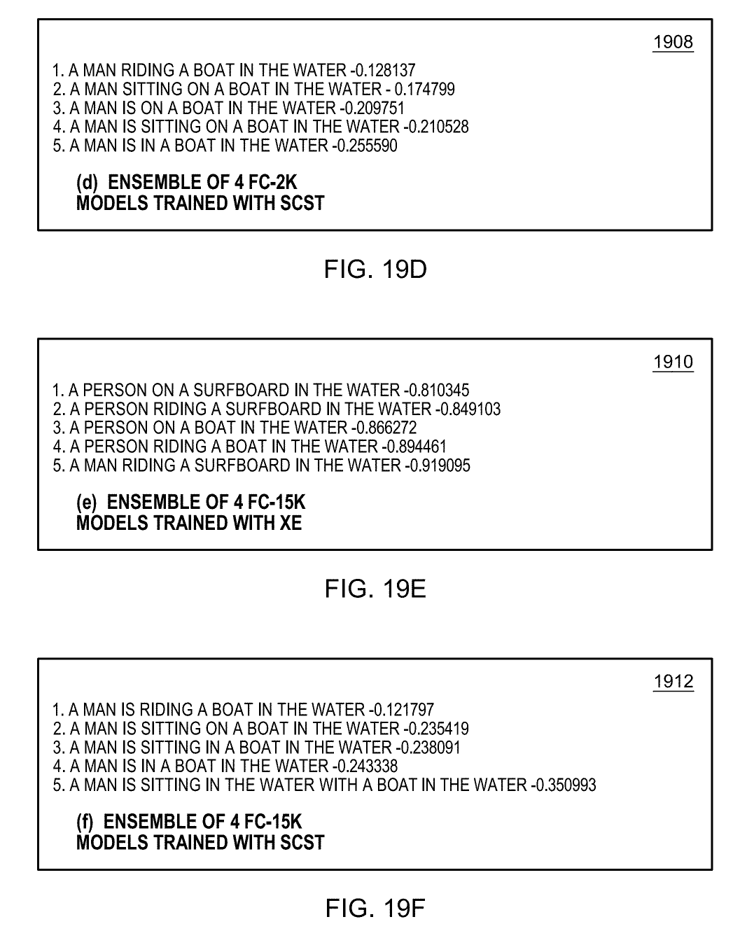

Screenshots 1902-1912 of FIGS. 19A-19F (collectively FIG. 19), respectively, are a series of captions generated with respect to image 1800 by the various models (described above). Each caption reports the average log probability of the words in the caption. With respect to image 1800, which presents an object situated in an atypical context (that is, a car in the middle of a body of water), the FC models (FIGS. 19C-19F) fail to give an accurate description while the attention models (FIGS. 19A and 19B) handle the previously unseen image composition well. The models trained with SCST return a more accurate and more detailed summary of the image.

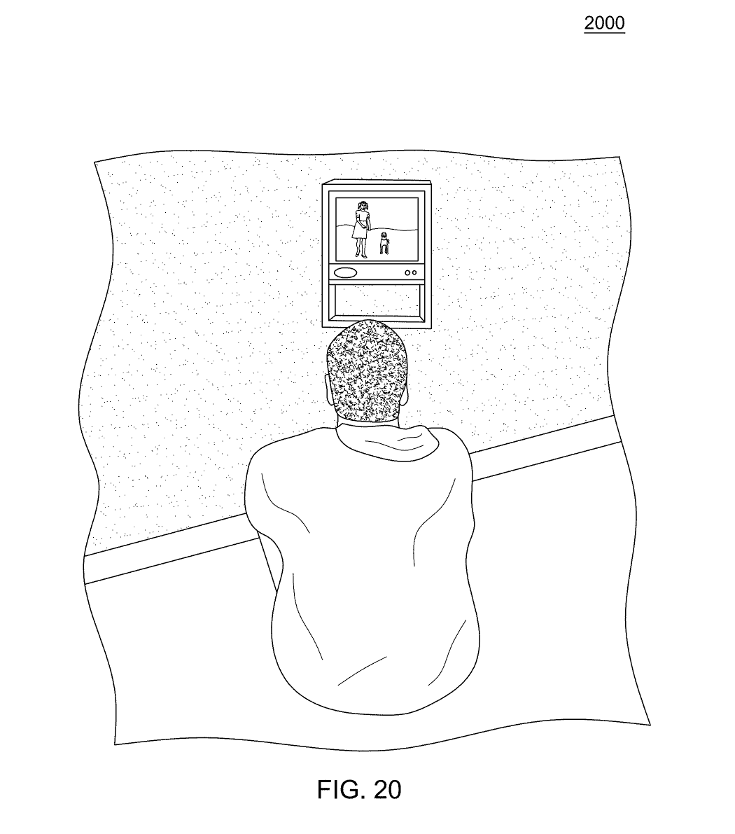

Image 2000 of FIG. 20 is an image from the objects out-of-context (OOOC) dataset of images depicting a person looking at a television screen while sitting on the side of the road.

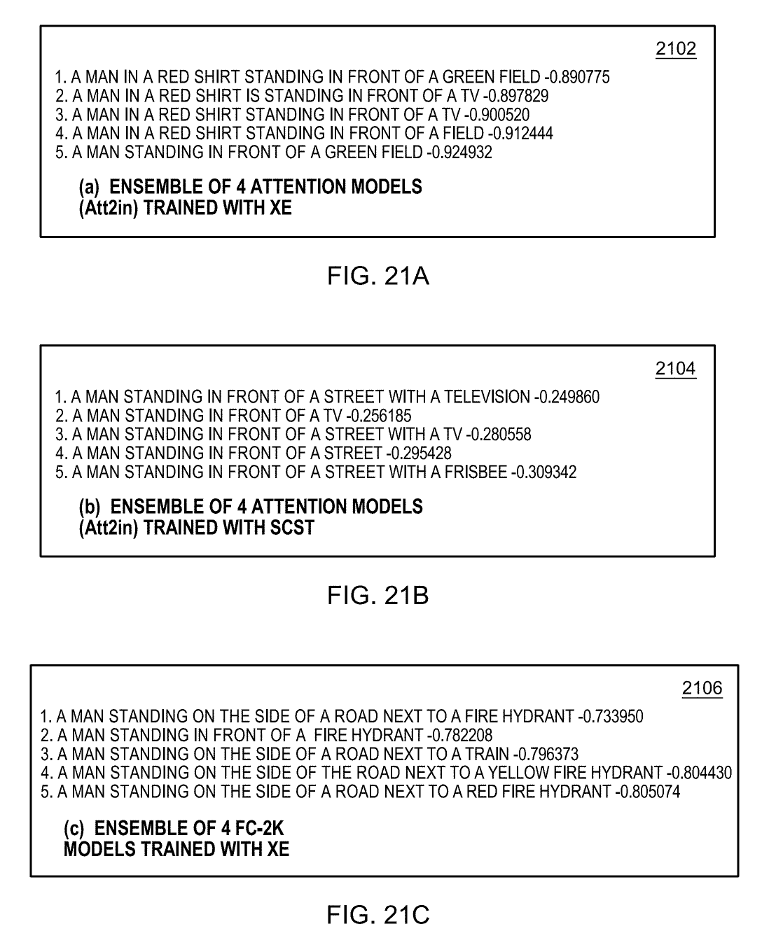

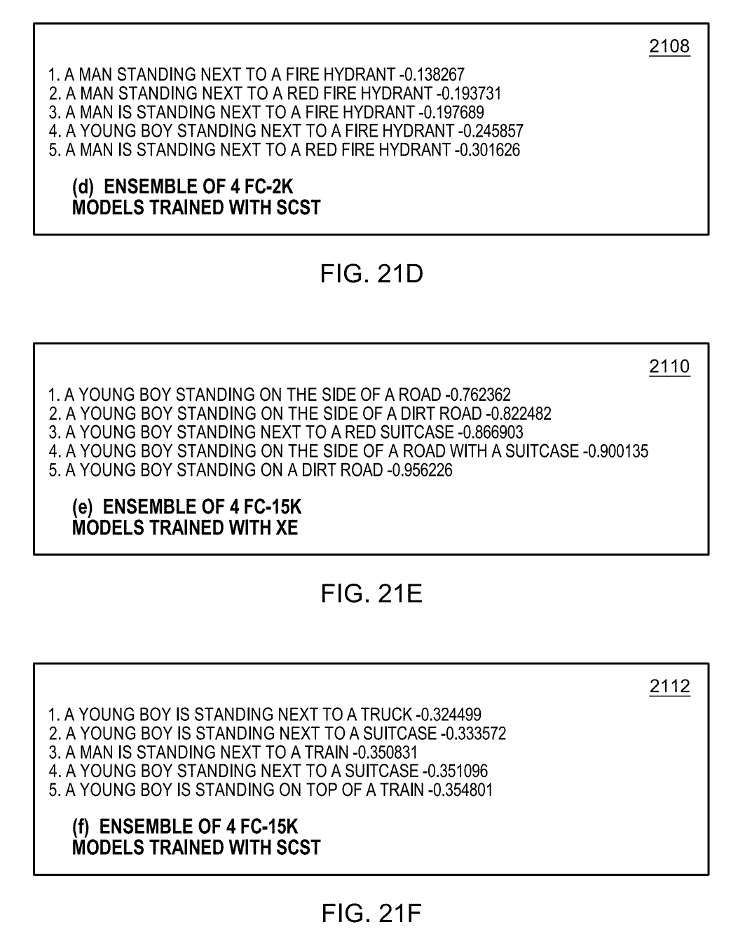

Screenshots 2102-2112 of FIGS. 21A-21F (collectively FIG. 21), respectively, are a series of captions generated with respect to image 2000 by the various models (discussed above). Each caption reports the average log probability of the words in the caption. With respect to image 2000, which presents an object situated in an atypical context (that is, a person looking at an unplugged television screen while sitting on the side of the road), the FC models (FIGS. 21C-21F) fail to give an accurate description, while the attention models (FIGS. 21A and 21B) handle the previously unseen image composition well. The models trained with SCST return a more accurate and more detailed summary of the image.

Some embodiments of the present invention may include one, or more, of the following features, characteristics and/or advantages: (i) trains a structured prediction system; (ii) receives input content C for analysis; (iii) analyzes the input content C to form a probability distribution over possible output results A, p(A|C); (iv) executes a search procedure on p(A|C) to identify K probable outputs, S_p={A_p1, A_p2, . . . , A_pK}; (v) executes a distribution characterization procedure to obtain J [exemplary] outputs S_e={A_e1, A_e2, . . . , A_eJ}; (vi) utilizes a reward assessment system to assign a reward value; (vii) identifies an augmented set of rewards based the R (A_i); and (viii) updates the probability distribution over output results A, p(A|C), based on the augmented rewards.

Some embodiments of the present invention may include one, or more, of the following features, characteristics and/or advantages: (i) uses the search procedure at test time (for example, at system deployment); (ii) the probability distribution outputs contains additional structural assumptions (for example, for outputs A=[A_1, A_2] and input content C=[C_1, C_2], p(A|C)=p(A_1|C_1) p(A_2|A_1, C_2) is a distribution with additional structural assumptions); (iii) uses sampling as the distribution characterization procedure (such as Monte Carlo); (iv) uses clustering as the distribution characterization procedure; (v) the augmented reward R′(A_ei) is a function: f(R(A_ei), R(A_p1), R(A_p2), . . . , R(A_pK)) for all A_ei in S_e; (vi) improves the possible output results A, p(A|C) based on increasing the probability of the outputs A_ei, which have a high augmented reward R′(A_ei); and/or (vii) improves the possible output results A, p(A|C) based on decreasing the probability of the outputs A_ei having a low augmented reward R′(A_ei).

Some embodiments of the present invention may include one, or more, of the following features, characteristics and/or advantages: (i) the content C is an image; (ii) the outputs results, A, are text; (iii) the search algorithm is an A*/beam search; (iv) uses a deep convolutional neural network (CNN) to encode the image; (v) uses a long short term memory (LSTM) recurrent neural network (RNN) to generate an output distribution over captions for the image; (vi) uses the test-time search procedure rather than learned estimates of future reward; (vii) normalizes the reward signal for each output in S_e; and (viii) harmonizes training with test conditions and reduces estimation variance in the normalization.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Word: any symbol; not limited to natural language works.

Text stream: any type of symbol string that represents a meaningful pattern; not limited to natural language sentences.

What is claimed is:

1. A computer-implemented method comprising:
selecting a word for use as a next word in a text stream;
determining, by an algorithm, an expected future reward value for the word using a test policy including a training policy and a test-time inference procedure; and
normalizing a set of expected future reward estimate(s) using the expected future reward value for the sampled word using the test policy.

2. The method of claim 1, wherein the test-time inference procedure is utilized only in the normalization of the set of expected future reward estimate(s).

3. The method of claim 1, where the test-time inference procedure involves any approximate search algorithm such as A*, or exhaustive search.

4. The method of claim 1, where the test-time inference procedure is greedy search.

5. The method of claim 1, where the selection of words involves sampling from the policy being learned, (prioritized) training or experienced data, or any other policy.

6. The method of claim 1, wherein the selection of words involves leveraging a similarity metric defined over words, sentences, or phrases (e.g. a clustering of words, sentences, or phrases).

7. The method of claim 1, wherein the test-time inference procedure involves leveraging a similarity metric defined over words, sentences, or phrases (e.g. a clustering of words, sentences, or phrases).

8. The method of claim 1 wherein the algorithm is a REINFORCE type algorithm.

9. The method of claim 1 wherein the algorithm is an actor-critic policy-gradient type algorithm.

10. The method of claim 1 wherein the algorithm is Q-LEARNING or SARSA type algorithm.

11. A computer program product (CPP) comprising:
a computer readable storage medium; and
computer code stored on the computer readable storage medium for causing a processor(s) set to perform at least the following operations:
selecting a word for use as a next word in a text stream,
determining, by an algorithm, an expected future reward value for the word using a test policy including a training policy and a test-time inference procedure, and
normalizing a set of expected future reward estimate(s) using the expected future reward value for the sampled word using the test policy.

12. The CPP of claim 11, wherein the test-time inference procedure is utilized only in the normalization of the set of expected future reward estimate(s).

13. The CPP of claim 11, where the test-time inference procedure involves any approximate search algorithm such as A*, or exhaustive search.

14. The CPP of claim 11, where the test-time inference procedure is greedy search.

15. The CPP of claim 11, where the selection of words involves sampling from the policy being learned, (prioritized) training or experienced data, or any other policy.

16. The CPP of claim 11, wherein the selection of words involves leveraging a similarity metric defined over words, sentences, or phrases (e.g. a clustering of words, sentences, or phrases).

17. The CPP of claim 11, wherein the test-time inference procedure involves leveraging a similarity metric defined over words, sentences, or phrases (e.g. a clustering of words, sentences, or phrases).

18. The CPP of claim 11 wherein the algorithm is a REINFORCE type algorithm.

19. The CPP of claim 11 wherein the algorithm is an actor-critic policy-gradient type algorithm.

20. A computer system comprising:
a processor(s) set;
a computer readable storage medium; and
computer code stored on the computer readable storage medium for causing the processor(s) set to perform at least the following operations:
selecting a word for use as a next word in a text stream,
determining, by an algorithm, an expected future reward value for the word using a test policy including a training policy and a test-time inference procedure, and
normalizing a set of expected future reward estimate(s) using the expected future reward value for the sampled word using the test policy.
